(19) United States
(12) Patent Application Publication
(10) Pub. No.: US 2003/0136576 A1
(43) Pub. Date: Jul. 24, 2003

(54) Printed circuit support having integrated connections and process for manufacturing such a support

(75) Inventor: Bertrand Joly, Sevres (FR)

Correspondence Address: SUGHRUE MION, PLLC, 2100 Pennsylvania Avenue, NW, Washington, DC, 20037-3213, US

(73) Assignee: NEXANS

(21) Appl. No.: 10/290,194

(22) Filed: Nov. 8, 2002

(30) Foreign Application Priority Data
Nov. 9, 2001 (FR) 01 14747

(51) Int. Cl. H01R 12/12

(52) U.S. Cl. 174/254; 174/258; 439/493; 174/268

(57) ABSTRACT

A printed circuit support comprises a substrate made of an insulating material, at least one electric current conveying path consisting of a metallization of the substrate, and at least one connection arrangement contiguous with the conveying path. The connection arrangement comprises at least one strip of metallized flexible plastic that forms a section of conductor and is electrically connected to the conveying path.

### BACKGROUND OF THE INVENTION

1. Field of the invention

The present invention relates to a printed circuit support having integrated connections and to a process for manufacturing such a support.

Conventionally, electrical cables are connected to printed circuit supports by means of separate connectors mounted on the support.

2. Description of the Prior Art

Patent document WO 00/42679 discloses a printed circuit support comprising a substrate made of electrically insulating material, a plurality of electric current conveying paths made of an electrically conducting material deposited on the substrate, and a plurality of connectors, also integrated and electrically connected to the paths. According to the example described, the substrate is made of a resin reinforced with glass fibers and the paths made of electrically conducting material may be made of copper and may be formed on the substrate in the usual manner by etching from complete copper layers. The connectors comprise a slot coated on its inner surface with a hard and electrically conducting material, such as nickel. The thickness of each slot is chosen so as to be less than the diameter of the conducting cable to be connected. Thus, when this cable is pushed into the slot, the inner surface of the latter cuts and displaces the insulation of the cable, causing the cable to be stripped and its conducting part to be brought into electrical contact with the inner surface of the slot.

Patent U.S. Pat. No. 4,973,262 discloses a printed circuit support comprising a substrate made of insulating material, an electric current conveying path made of an electrically conducting material on the substrate, and a connection arrangement formed from a part integrated into the substrate and contiguous with the conveying path, in which the substrate with its connection arrangement is made of a metallized plastic.

According to one embodiment, the connection arrangement comprises a molded slot on one edge of the support, the inner surface of which is metallized. The slot may include a cutting angular edge. The slot may be in the plane of the support or inclined at an angle of 90° to the plane of the support. The connection arrangement may include a molded groove on one edge of the support, the inner surface of which is metallized.

These connector arrangements allow the connection of cables to a printed circuit support without the need for separate connectors mounted on the support. However, this type of connector cannot be produced by machining, in particular by drilling, or molding in the plastic substrate. This requires relatively expensive machining or molding work on the support.

### SUMMARY OF THE INVENTION

The invention proposes to solve this problem and, to do so, it provides a printed circuit support comprising a substrate made of insulating material, at least one electric current conveying path consisting of a metallization of the substrate, and at least one connection arrangement contiguous with the conveying path, which connection arrangement comprises at least one strip of metallized flexible plastic that forms a section of conductor and is electrically connected to the conveying path.

According to a first embodiment, the strip is molded as a single piece with the substrate.

According to a second embodiment, the support comprises a flexible film fastened to the substrate piece and carrying the conveying path and the section of conductor of the connection arrangement.

Advantageously, the film is made of a plastic.

Preferably, the film is made of a polymer, preferably a polyethylene or a polyimide.

Moreover, metallization processes have been developed in recent years allowing plastic substrates to be metallized, one advantage of which resides in the fact that they are very easily implemented by molding or calendering.

One such process is described in the patent document EP 0 693 138.

This process of known type is a process for the positive-type metallization of a substrate piece made of a composite plastic containing a copolymer and particles of one or more metal oxides, comprising three successive steps, the first of which consists in irradiating that surface of the substrate piece to be metallized, by a light beam emitted by an excimer laser, the second consisting in immersing the irradiated piece in at least one autocatalytic solution containing metal ions and with no prior supply of palladium, with deposition of the metal ions as a layer on the irradiated surface, and the third step consisting in heat treating the metallized metallic piece so as to cause diffusion of the metal deposited in the composite.

Such a process allows various plastics, and in particular molded plastics, to be metallized.

The present invention exploits the use of such metallization processes to produce printed circuit supports with integrated connectors.

The invention also provides a process for metallizing a substrate piece, particularly a method suitable for the manufacture of a support as specified above and comprising three successive steps which are:

a step of coating the piece with a layer of a precursor composite, consisting of a polymer matrix doped with dielectric particles made of a photoreducing material,

a step consisting in irradiating that surface of the substrate piece to be metallized, by a light beam emitted by a laser,

a step consisting in immersing the irradiated piece in an autocatalytic solution containing metal ions, with deposition of the metal ions as a layer on the irradiated surface,

wherein the dimension of the dielectric particles is less than or equal to 0.5 microns.

The process described in patent document EP 0 693 138 requires the incorporation, into the mass of the plastic formed from a polymer, of a mineral substance dispersed in the plastic and formed from oxide particles, for example antimony, aluminum, iron, zinc and tin oxide particles, especially in a concentration by volume of greater than 1% and of variable size, but preferably of a size greater than 0.5 microns but not exceeding 50 microns. In addition, these oxides are made to diffuse into the plastic by the final heat treatment. The resulting adhesion is thus increased by making the metal diffuse toward the interior of the composite using the selective heating, of short duration, of the metal layer provided by a microwave oven.

Supplying mineral substances to the polymer in this way modifies the intrinsic properties of the polymer, this being prejudicial since the nature of the polymer is optimized for the application.

To solve this problem, it may be envisioned to provide, prior to the first step, a step of coating the piece with a layer of precursor composite, consisting of a polymer matrix doped with dielectric particles made of a photoreducing material.

Such a process is known from the patents U.S. Pat. No. 4,426,442 and U.S. Pat. No. 4,853,252.

According to these patents, the piece is precoated with a layer of photoreducing material. This layer consists of a polymer matrix doped with dielectric particles, more specifically, with titanium dioxide particles.

In the processes disclosed, the precise dimension of these particles is not considered and the layer may be up to 10 microns in thickness.

The “particle dimension” is understood to mean the average diameter of these particles.

However, it turns out that, when these particles have a relatively large dimension, the following technical problems occur.

Firstly, for a constant volume fraction of the particles in the polymer matrix, the adhesion forces of the subsequently deposited metal ions are weaker. It is therefore necessary to use large volume fractions to obtain good integrity of the metallization, which leads to a high material cost and limits the polymer selection possibilities, depending on the compatibility of the polymer with the particles.

In addition, to obtain a uniform metallization coating of metal ions, it is necessary to deposit a relatively large thickness of metal ions. This is also particularly expensive in terms of material and, in addition, a relatively rough coating is obtained.

Finally, the lateral resolution of a region thus metallized is poor. The expression “lateral resolution” is understood to mean the regularity of a border of such a region.

This is prejudicial to obtaining precise metallized regions, such as high-quality and economically profitable integrated-circuit tracks.

The process according to the invention solves these problems.

In addition, the preparation of such a composite can make use of the rapid development in the technology of nanoparticle-doped polymers and in particular, the chemical bonding between nanoparticles and a polymer matrix by means of molecular ligands.

The polymer matrix is made of a material selected for obtaining good adhesion at its interface with the substrate piece. Its selection therefore depends on the material of the substrate piece. Preferably, materials of the polyethylene, polypropylene or polyimide type are used.

Advantageously, the dielectric particles are made of a photoreducing material, and preferably the dielectric particles are oxides chosen from ZnO, TiO₂, ZrO₂, Al₂O₃ or CeO₂.

Advantageously, the layer of composite has a thickness of at most one micron, it being possible for this thickness to be less if the size of the oxide particles is nanometric.

The layer of composite may be applied using conventional techniques, such as spin-on deposition, dispersion, immersion coating, screen printing, spraying or extrusion in the case of a substrate piece in the form of a cable.

According to a preferred embodiment, in the case of a substrate piece made of a polymer plastic, the layer of composite is applied to the substrate piece by laser lamination, the dielectric particles being deposited on the surface of the substrate piece made of polymer plastic, prior to laser heating, using a dispersion technique, or being injected by means of a nozzle during the laser heating.

This is an implementation example. It is understood that, even in the case of a polymer substrate piece, it may be envisioned to coat this piece with a layer of composite instead, as described above, of encapsulating the oxide powder on the surface of the substrate piece.

After the layer of composite has been deposited in the second step of the process, this layer is irradiated by a pulsed UV laser beam. This step is aimed at activating the surface of the small dielectric particles bared by simultaneous ablation of the encapsulating polymer, for the subsequent autocatalytic deposition of metal, for example, copper. This operation may be carried out in two different ways: irradiation of the entire surface of the piece or irradiation through a projection mask so as to activate only the surface to be metallized.

If the composite is deposited by screen printing, the future tracks are already traced. The entire surface of the substrate piece can then be irradiated, since only the tracks will be activated for the subsequent autocatalytic deposition.

The use of dielectric nanoparticles has several advantages. Very smooth surfaces with a high lateral resolution are obtained. High degrees of coverage of the surface of the activated dielectric area are also obtained, making it possible to obtain metallization as a homogeneous film with an adhesion of more than 1 kg/mm². For example, in the case of ZnO particles 100 nm in diameter, the surface coverage by the activated area may exceed 50% for a volume fraction of nanoparticles not exceeding 10%.

The use of a projection mask during laser irradiation makes it possible to dispense with the application of a photolithographic step in order to define the metallization region, in the case of partial metallization. In this regard, the process is compatible with changes in level between two surfaces of the product to be metallized.

The third step of the process comprises the autocatalytic deposition of metal, preferably copper, by immersing the piece in an autocatalytic solution, as carried out in the prior art cited in the preamble of the description. In the case of partial metallization, with an entirely covered surface, a photolithographic step is then needed between laser irradiation and immersion in the autocatalytic solution in order to define the surfaces to be metallized.

After autocatalytic deposition, which results in a thickness of at most a few microns, the film may be supplemented by electrodeposition using known processes. This deposition is more rapid and less expensive than autocatalytic deposition, which is essential only in an initial phase for obtaining good adhesion to the surface of the oxide and for producing a continuous film. It is also possible for the autocatalytic coating deposited to be strengthened by another process, for example by a wave deposition of tin.

This novel process makes it possible to separate the optimization of the properties of the substrate piece made of polymer plastic on the one hand from the constituents of the metallization on the other hand. The polymer used for the metallization during the first step may differ from the substrate piece. For example, it is possible to select for the metallization a polymer material which has a relatively high absorption at a wavelength of 248 nm which is the wavelength of the most common commercially available excimer lasers.

A first example of how the process is implemented is described in detail below.

In the first step, a layer of composite consisting of a polymer filled with zinc oxide ZnO is applied by laser lamination to a substrate piece made of polymer material, for example polycarbonate. This is carried out by making the polymer surface move at a constant speed of about 10 to 100 mm/s under the continuous wave laser beam, preferably a CO₂ laser beam. The power of the laser is selected within a range from several tens to several hundreds of watts, so as to heat the polymer surface and to allow encapsulation of the ceramic particles beneath the surface of the polymer rendered viscous. The ceramic powder is deposited on the polymer surface prior to laser heating, using a conventional dispersion technique, or it is injected by means of a nozzle during the laser heating. By this technique, the ZnO particles having a dimension of 0.5 microns are embedded in the treated polymer surface. The thickness and the composition of the composite layer may be adjusted by varying the parameters of the laser, that is to say its power and its scanning speed.

In the second step of the process, the composite layer is activated by a pulsed UV excimer laser (193 nm wavelength). This operation is carried out with the following laser parameters: 50 to 200 pulses with a fluence of close to 500 mJ/cm².

Autocatalytic deposition of copper is then carried out in the third step of the process. The metallization is produced only in the laser-treated regions. In the metallization region, an adhesion of 1.4 kg/mm² to the copper is then obtained. This adhesion may be measured by a standard tensile test. The tensile tests are carried out after fixing, by adhesive bonding, metal studs (2 mm in diameter) to the copper tracks to be tested. These studs are pulled at right angles to the specimen with an increasing force until separation, so as to determine the adhesion.

A second example of how to implement the process is described in detail below.

In the first step, a layer of composite consisting of polymer filled with zinc oxide ZnO particles having a mean diameter of less than or equal to 0.5 microns is applied to a substrate piece of polymer material by the spin-on process with a rotation of 500 to 2000 rpm.

The substrate piece is a polycarbonate or silicon film, having a thickness of 500 microns.

The polymer matrix is made of poly[bisphenol A carbonate-co-4,4′-(3,3,5-trimethylcyclohexylidene) diphenol carbonate] and the composite is contained in a solvent, preferably 1,2-dichloroethane.

Standard dispersing agents are added to this precursor material.

In the second step of the process, the composite layer is activated by a pulsed UV excimer laser (b 193 nm wavelength). This operation is carried out with the following laser parameters: 1 to 5 pulses of a fluence of close to 500 mJ/cm².

Autocatalytic deposition of copper is then carried out in the third step of the process.

In addition, the invention relates to a piece metallized by implementing the process, comprising a substrate piece consisting of a flexible film.

Advantageously, the film is made of a plastic and in particular a polymer, preferably polycarbonate.

Apart from solving the abovementioned technical problems, the invention makes it possible to produce a thin film of metallized plastic, the thickness of which is particularly small. This type of film may also be applied in metallizing substrate regions of complex shape. This is because in such regions, it may prove to be very complicated or even impossible to carry out a direct metallization treatment according to the invention. For example, it may prove to be difficult to carry out laser irradiation in recessed shapes in which metallization by the process according to the invention is desired over the entire surface of the recess. By virtue of the invention, in such cases, the metallized film is deposited, for example, by adhesive bonding to the surface.

It should be noted that the metal ions can be deposited on the irradiated surface of the attached film either before or after bonding of the latter. Depending on the curvatures, it may be advantageous to do so afterwards. This is possible since the laser-irradiated region remains active long after irradiation. Experimentally, it has been found that this activation lasts for several months after irradiation.

A third example of how to implement the process, relating more specifically to the manufacture of such a metallized film, is described in detail below.

A polyethylene, polyimide or Mylar film is extruded with, for example, a thickness of 50 microns. More generally, a thickness of 10 microns to 1 mm may be envisioned. This film is passed continuously and in series through a tank for depositing the precursor composite and then through a drying oven followed by heating, for example, by CO₂ laser irradiation, and then irradiation by an activating excimer laser. Passage through the autocatalytic solution may take place at a slow speed or statically, until a metal thickness of 0.5 to 10 microns in thickness is obtained.

Such a laminated composite film may therefore be manufactured continuously.

Selective metallization, possibly taking the form of complex surfaces of high definition with a precision of around one micron, may also be carried out in order to produce electromagnetic shielding of the screen type or electronic circuitry in applications of the type including printed circuits, integrated circuits, magnetic cards, smart cards, etc.

The elementary films are then treated sequentially in the phase of irradiation by excimer laser through a mask so as to imprint, on the film, the exact and precise shape of the desired metallization that will appear when it passes through the autocatalytic solution.

It should also be noted that applications in the manufacture of selective membranes, films for decorative use or films intended for printing may also be envisioned using the process according to the invention.

The invention will now be described below in greater detail with the aid of the figures, which show only preferred embodiments of the invention.

### BRIEF DESCRIPTION OF THE DRAWINGS

FIG. 1 is a perspective view of a printed circuit support according to a first embodiment of the invention.

FIG. 2 is a perspective view of a printed circuit support according to a second embodiment of the invention.

FIG. 3 is a partial sectional view according to a first variant.

FIG. 4 is a partial sectional view according to a second variant.

### DETAILED DESCRIPTION OF THE PREFERRED EMBODIMENT

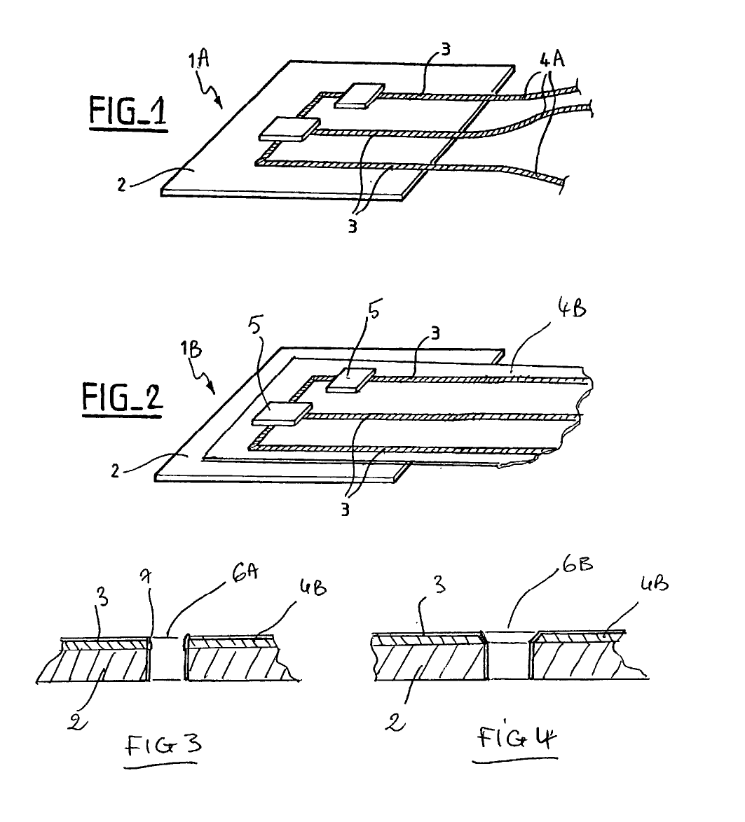

As shown in FIG. 1, a printed circuit support 1A comprises a substrate 2 made of insulating material and at least one electric current conveying path 3 made of an electrically conducting material on the substrate 2, and at least one connection arrangement 4A formed from a part integrated into the substrate 2 and contiguous with the conveying path 3.

According to the invention, the substrate 2 with its connection arrangement 4 is made of a molded and metallized material.

Preferably, this material is a plastic, but it may, according to the invention, also be a ceramic or a semiconductor.

In the case of a plastic, the latter may be polycarbonate, polybutadiene, polyamide, polypropylene, polyethylene, polyethylenestyrene [sic], PVC, ABS, polyimide, fluoropolymer or polyoxymethyl [sic], and the metallization is preferably carried out by means of the metallization process described above. The metal used is preferably copper, nickel, palladium, aluminum or titanium.

According to the first embodiment shown in FIG. 1, the connection arrangement 4A comprises strips of metallized flexible plastic each forming a section of conductor, each strip being electrically connected to a conveying path 3.

Preferably, these strips 4A are molded as a single piece with the support 2 and are metallized during the metallization of the electric current conveying paths 3 on the substrate 2.

This arrangement allows flexible extension of the transport paths 2 and a connection of the latter which is displaced and spaced from the support.

According to a second embodiment shown in FIG. 2, the support 1B comprises a flexible film 4B of plastic fixed, advantageously bonded, to the substrate piece 2 and carrying conveying paths 3 and the conductor sections of the connection arrangement.

This film consists of a polymer, preferably polyethylene or polyimide. The metallization is preferably carried out by the metallization process described above. The metal used is preferably copper, nickel, palladium, aluminum or titanium.

In its connection part not fixed to substrate 2, this strip may be cut into thinner strips carrying a metallization so as to form conducting sections of the same type as those described in FIG. 1.

According to another variant, this part of the strip is left as it is and forms a ribbon of parallel conducting connections.

The conveying paths 3 are metallized either before bonding of the film 4B, or after bonding of the film 4B to the substrate 2.

Once this film 4B has been bonded to the substrate 2, the components 5 are fixed by their connection leads in holes 6A, 6B provided through the film 4B and the substrate 2, having a diameter of between 35 and 150 microns.

According to a variant shown in FIG. 3, the hole 6A is drilled through the film 4B and the substrate 2 along the trajectory of a conveying path 3. The wall of the hole is metallized and a wave-applied tin connection 7 is made on the edge of the film 4B.

According to another variant shown in FIG. 4, the hole 6B is drilled through the film 4B and the substrate 2 along the trajectory of a conveying path 3. This hole 6B has a flared mouth which is metallized during metallization of the conveying path 3. The wall of the hole is metallized and a wave-applied tin connection is possibly made at the connection of the two metallizations.

Compared with the technique currently used for connection by separate standard connectors, the invention has the advantage of comprising only the interfaces necessary for the connections and therefore results in a substantial saving in means. This is because these standard connectors conventionally comprise many connection points, possibly numbering several tens of points, and therefore in use, a not insignificant number of connection points not used.

The description relates to a plastic substrate, but the invention may apply to other materials such as doped or undoped polymers, ceramics, semiconductors, or other materials.

There is claimed:

1. A printed circuit support comprising a substrate made of insulating material, at least one electric current conveying path consisting of a metallization of the substrate, and at least one connection arrangement contiguous with said conveying path, wherein said connection arrangement comprises at least one strip of metallized flexible plastic that forms a section of conductor and is electrically connected to said conveying path.

2. The support claimed in claim 1, wherein said strip is molded as a single piece with said substrate.

3. The support claimed in claim 1, which comprises a flexible film fastened to the substrate piece and carrying said conveying path and said section of conductor of said connection arrangement.

4. The support claimed in claim 3, wherein said film is made of a plastic.

5. The support claimed in claim 4, wherein said film is made of a polymer, preferably a polyethylene or a polyimide.

6. A process for manufacturing a printed circuit support claimed in one of the preceding claims by metallization of a substrate piece, comprising three successive steps which are a step of coating said piece with a layer of a precursor composite, consisting of a polymer matrix doped with dielectric particles made of a photoreducing material, a step consisting in irradiating that surface of said substrate piece to be metallized, by a light beam emitted by a laser, and a step consisting in immersing the irradiated piece in an autocatalytic solution containing metal ions, with deposition of said metal ions as a layer on the irradiated surface, wherein the dimension of said dielectric particles is less than or equal to 0.5 microns.

7. The process claimed in claim 6, wherein said dielectric particles are oxides chosen from ZnO, TiO₂, ZrO₂, Al₂O₃ or CeO₂.

8. The process claimed in one of the preceding claims, wherein said layer of composite has a thickness of about one micron.

9. The process claimed in one of the preceding claims, wherein said final step is supplemented with an electrodeposition step.

10. The process claimed in one of the preceding claims, wherein said substrate piece is made of a polymer plastic and said layer of composite is applied to said substrate piece of polymer plastic by laser lamination.

11. The process claimed in claim 10, wherein said dielectric particles are deposited on the surface of said substrate piece made of a polymer plastic, prior to laser heating, using a dispersion technique.

12. The process claimed in claim 10, wherein said dielectric particles are injected by means of a nozzle during the laser heating.
